(19) United States
(12) Patent Application Publication
(10) Pub. No.: US 2023/0334396 A1
(43) Pub. Date: Oct. 19, 2023

(54) WORK INSTRUCTION SYSTEM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi, Kyoto (JP)

(21) Appl. No.: 18/024,975

(22) PCT Filed: Mar. 8, 2022
(86) PCT No.: PCT/JP2022/010092

§ 371 Date: Mar. 7, 2023

(30) Foreign Application Priority Data
Mar. 31, 2021 (JP) 2021-059280

(51) Int. Cl. G06Q 10/0631

(52) U.S. Cl. CPC G06Q 10/06316

(57) ABSTRACT

A work instruction system automatically presents a work procedure in a next step to a worker, based on current work progress by the worker. The work instruction system includes: a camera and an input section for acquiring information on a worker's posture; a motion estimation section for calculating worker's skeleton information and estimating a worker's motion, based on the information on the worker's posture; a step identification section for identifying a current step performed by the worker, based on the worker's estimated motion and also based on work procedures that are predetermined respectively in a plurality of steps; a tablet computer capable of presenting, to the worker, an image indicating one of the work procedures in these steps; and an instruction section for allowing the tablet computer to present, from among the work procedures in these steps, a work procedure in the next step that follows the identified current step.

### TECHNICAL FIELD

The present invention relates to a work instruction system. In particular, the present invention relates to a work instruction system that is applicable to a cell manufacturing system and that automatically presents a work procedure in a next step to a worker.

### BACKGROUND ART

Traditionally, a line production system that is suitable for mass production of a limited variety of models was prevailing in manufacturing plants for industrial equipment, electronic equipment, etc. In the line production system, a product is completed through many workers, with each worker being assigned with a single type or a few types of work and aligned along a travelling direction of a conveyor belt. Recently, the trend has been shifting toward a cell manufacturing system that is suitable for low-volume production of a wide variety of models. In the cell manufacturing system, a product is completed by a single worker or a few workers, with each worker being assigned with many types of work.

The cell manufacturing system can meet diversified consumer needs, but has its own problem. Since each worker is assigned with a number of steps, a work procedure manual that specifies work procedures in respective steps tends to be complicated. A work procedure check gives a heavy burden on the worker.

Previous techniques have proposed to solve this problem by automation, for example, by automatically giving work instructions to the workers or automatically monitoring whether the work is performed properly.

For example, PTL 1 discloses an assembly instruction display device using an RFID reader wearable on a wrist or an arm of a worker. When the RFID reader detects an RFID tag attached to an object such as a jig or a component, assembly manual data for the task associated with the object is played on a display device or the like for a standard time.

PTL 2 discloses a work monitoring system using a head mount display wearable on the head of a worker. The work monitoring system detects contours and movements of worker's hands (e.g., changes in the hand contours), compares the detected hand movements with hand movements according to standard work information that indicates a proper work description, then determines, based on the comparison result and from among all work steps, a work phase corresponding to a worker's motion, and thus automatically checks omission of a work phase and inconsistency in procedures.

### CITATION LIST

### Patent Literature

PTL 1: JP 2008-203922 A1
PTL 2: JP 2008-003781 A1

### Summary of Invention

### Technical Problem

However, the assembly instruction display device disclosed by PTL 1 has some drawbacks. First, this assembly instruction display device is unsuitable to a work that does not use a jig, a component, or the like to which the RFID tag is attached. Second, if the detection device (the RFID reader, etc.) to be worn by the worker is lost, the assembly manual data cannot be presented to the worker as intended, and eventually the work is suspended.

The work monitoring system disclosed by PTL 2 also has some drawbacks. First, the angle of view of the head mount display varies with the physique of the worker or other factors. Such a variation may deteriorate detection accuracy for the hand contours, and a detection error in the hand contours may then cause the work monitoring system to determine a wrong work phase. Second, as stated in relation to the device of PTL 1, if the head mount display is lost, the work is suspended.

The present invention is made in view of these drawbacks, and aims to provide a technique for reliably enabling a worker to recognize a work procedure in the next step, by a simple configuration without attaching any detection device to the worker and to a component, a jig, and the like.

### Solution to Problem

To achieve this object, the work instruction system according to the present invention is arranged to identify a current step performed by a worker, based on a posture of the worker, and to automatically present a work procedure in the next step to the worker.

Specifically, the present invention relates to a work instruction system that automatically presents a work procedure in a next step to a worker, based on current work progress by the worker. The work instruction system includes: an information acquisition section that acquires information on a posture of the worker; a motion estimation section that calculates skeleton information on the worker and estimates a motion of the worker, based on the information acquired by the information acquisition section; a step identification section that identifies a current step performed by the worker, based on the motion of the worker estimated by the motion estimation section and also based on work procedures that are predetermined respectively in a plurality of steps; a display section that is capable of presenting, to the worker, an image indicating one of the work procedures in the plurality of steps; and an instruction section that allows the display section to present, from among the work procedures in the plurality of steps, a work procedure in the next step that follows the current step identified by the step identification section.

Since the calculation of the skeleton information on the worker and the estimation of the motion of the worker are based on the information on the posture of the worker acquired by the information acquisition section, this work instruction system can estimate the worker's motion with higher precision than the case of detecting a worker's contour or the like. Besides, for the estimation of the worker's motion, the work instruction system can omit the detection device to be attached to the worker and to a component, a jig, and the like. The work instruction system is therefore applicable to a work that does not use a jig, a component, or the like, and can avoid a suspension of a work due to loss of the detection device or a similar trouble.

Further, this work instruction system is configured to identify the current step performed by the worker, based on the estimated motion of the worker and also based on the work procedures in the plurality of steps, and is configured to present, to the worker and using the display section, the work procedure in the next step that follows the identified current step. As a result, the work instruction system reliably enables the worker to recognize the work procedure in the next step, in advance of the next step. Eventually, in the cell manufacturing system in which the work procedure manual tends to be complicated, this configuration can save the trouble of consulting the work procedure manual again and again to check the work procedure in the next step, and can thereby reduce the burden on the worker.

Note that the motion of the worker does not always correspond to any of the work procedures described in the work procedure manual. Due to an oversight, a mistake, or other causes, there may possibly be a discrepancy between the work performed by the worker and the steps.

To address this situation, the work instruction system may be configured to include an alarm section that is capable of giving a warning to the worker. When the motion of the worker estimated by the motion estimation section corresponds to none of the work procedures in the plurality of steps, the step identification section is configured to determine that the motion of the worker has deviated from the work procedures. When the step identification section has determined that the motion of the worker has deviated from the work procedures, the instruction section is configured to activate the alarm section.

By giving a warning to the worker, the work instruction system can allow the worker to recognize easily that his/her motion has deviated from the work procedures.

### Advantageous Effects of Invention

As described above, the work instruction system according to the present invention reliably enables a worker to recognize a work procedure in the next step, by a simple configuration without attaching any detection device to the worker and to a component, a jig, etc.

### BRIEF DESCRIPTION OF DRAWINGS

FIG. 1 is a schematic block diagram that shows the work instruction system according to an embodiment of the invention.

FIG. 2 is a schematic drawing that illustrates an example of a work procedure manual.

FIG. 3 is a schematic explanatory drawing that illustrates a method of estimating a motion of a worker.

FIG. 4 is a schematic drawing that illustrates an example of a work procedure presented to the worker.

FIG. 5 is a flowchart that shows an example of a procedure according to the work instruction system.

### DESCRIPTION OF EMBODIMENTS

Embodiments for carrying out the present invention are described below with reference to the drawings.

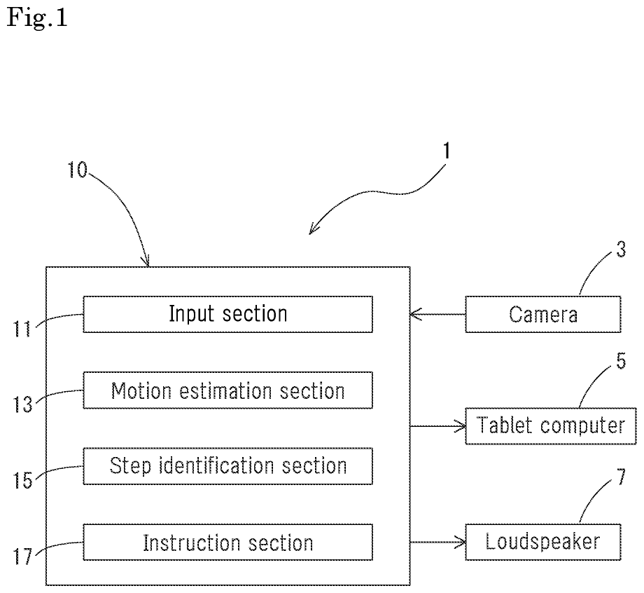

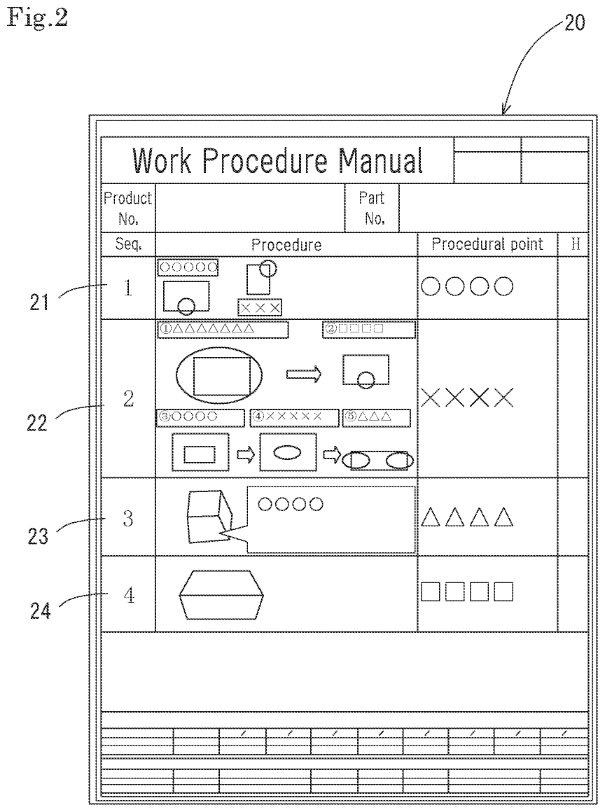

FIG. 1 is a schematic block diagram that shows a work instruction system 1 according to the present embodiment. FIG. 2 is a schematic drawing that illustrates an example of a work procedure manual 20. The work procedure manual 20 shown in FIG. 2 should be understood as an imaginary manual for describing the present embodiment, and should not be taken as a real manual for specifying an actual manufacturing procedure.

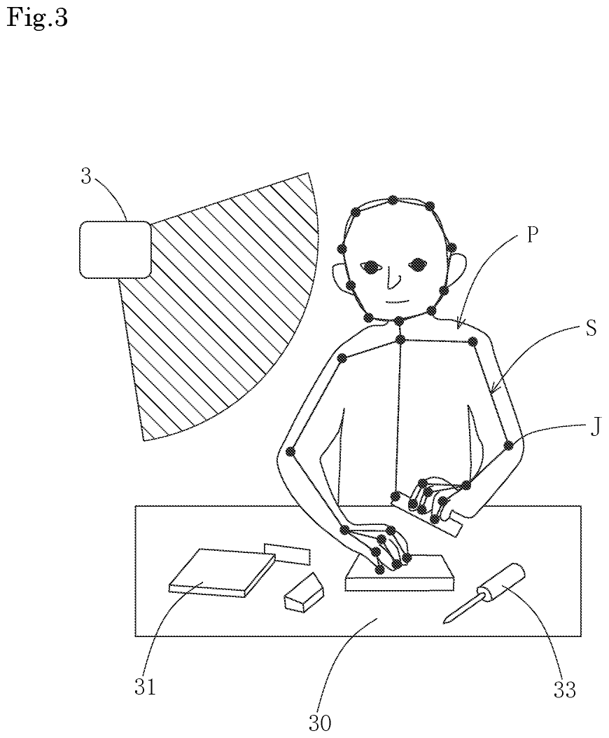

The work instruction system 1 is applied to a cell manufacturing system in which a product is completed by a single worker P (see FIG. 3) in a manufacturing plant or the like. The work instruction system 1 is configured to automatically identify a current step performed by the worker P from among a plurality of steps described in the work procedure manual 20, based on current work progress by the worker P, and to automatically present a work procedure in the next step to the worker P.

To be more specific, the cell manufacturing system is suitable for low-volume production of a wide variety of models and can meet diversified consumer needs. In the cell manufacturing system, however, the worker P is assigned with a number of steps, and the work procedure manual 20 that specifies work procedures in respective steps tends to be complicated. For example, the work procedure manual 20 shown in FIG. 2 contains four steps (steps 21, 22, 23, and 24), and describes different procedures and procedural points for the respective steps. A work procedure check gives a heavy burden on the worker P.

In this respect, the work instruction system 1 according to the present embodiment is configured to provide work instructions for a next step properly, by capturing an image of the worker P by means of a camera 3, identifying a current step performed by the worker P by means of a control device 10, based on current work progress by the worker P, and then, in advance of the next step, presenting a work procedure in the next step to the worker P by means of a tablet computer 5. The work instruction system 1 that can provide work instructions in this manner is hereinafter described in detail.

As shown in FIG. 1, the work instruction system 1 according to the present embodiment includes the control device 10, the camera 3, the tablet computer 5, and a loudspeaker 7. The camera 3, the tablet computer 5, and the loudspeaker 7 are connected independently to the control device 10 by wire or wirelessly.

The control device 10 is, for example, a computer such as a PC. The control device 10 is mainly composed of, among others, a central processing unit (CPU) for executing various arithmetic processing, a read only memory (ROM) for storing programs and data, and a random access memory (RAM) for temporarily storing data and information generated during the arithmetic processing by the CPU. As shown in FIG. 1, the control device 10 includes an input section 11, a motion estimation section 13, a step identification section 15, and an instruction section 17. The control device 10 is configured to execute control processing of the input section 11, the motion estimation section 13, the step identification section 15, and the instruction section 17, by implementing various programs stored in the ROM on the CPU.

The camera 3 is installed near a work station 30 (see FIG. 3) where the worker P works. The camera 3 is configured to sequentially capture images of the worker P at work, the top surface of the work station 30, and the like, and to transmit captured image data to the input section 11. Images of the worker P may be captured by a single camera 3 as described in the present embodiment or may be captured by a plurality of cameras 3.

The input section 11 is configured to process the image data transmitted from the camera 3, and to acquire a posture (a body position in a certain orientation or in motion) of the worker P in association with, for example, the captured time, the capturing angle of camera 3, and the like. The camera 3 and the input section 11 in the present embodiment correspond to “an information acquisition section that acquires information on a posture of the worker” in the claims of the present invention.

FIG. 3 is a schematic explanatory drawing that illustrates a method of estimating a motion of the worker P. The motion estimation section 13 is configured to calculate skeleton information on the worker P, based on the information acquired by the camera 3 and the input section 11, and thereby to estimate a motion of the worker P. To be more specific, the motion estimation section 13 extracts moving parts (joints J) of the worker P from the sequentially captured image data, as shown in FIG. 3. The motion estimation section 13 is configured to calculate skeleton information (see the skeleton model S in FIG. 3) based on the extracted joints J, and thereby to estimate a certain motion of the worker P.

This configuration enables high-precision analysis of the motion of the worker P, without requiring the worker P to wear an RFID reader and without using a motion capture or the like. In the method that requires the worker P to wear the detection device such as the RFID, loss of the detection device is assumed to render detection of the motion of the worker P difficult and to suspend the work eventually. On the other hand, the present embodiment estimates a motion of the worker P from the image data, and thus can avoid a suspension of a work due to loss of the detection device or a similar trouble.

The step identification section 15 is configured to identify a step that is currently performed by the worker P (a current step), based on the motion of the worker P estimated by the motion estimation section 13 and also based on the work procedures that are predetermined respectively in the plurality of steps 21, 22, 23, and 24. Specifically, in order to identify the current step performed by the worker P, the step identification section 15 is configured to determine automatically, by artificial intelligence-based (AI-based) machine learning, a type of work in a step corresponding to the estimated motion of the worker P from among the four steps 21, 22, 23, and 24 described in the work procedure manual 20.

The type of work corresponding to the motion of the worker P is determined, for example, by following judging factors: (1) the positions of the hands of the worker P on/over the work station 30; (2) the object touched by the worker P on/over the work station 30; (3) the stationary period of the hands and the type of motion by the worker P; (4) a sequence of (1) to (3); and the like.

For example, the step identification section 15 takes following factors as the judging factors: (1) the step identification section 15 presumes an area on/over the work station 30 in which the left or right hand of the worker P is present, according to the estimated motion of the worker P and the image data of the top surface of the work station 30; (2) the step identification section 15 presumes that the worker P has touched a specific component 31 or a specific tool 33, according to the estimated motion of the worker P and the image data of the top surface of the work station 30; (3) the step identification section 15 presumes that the hand(s) of the worker P has/have stayed (remain(s) stationary) in a certain area for a given period of time, or presumes that the hand(s) of the worker P has/have turned, pushed, struck, or otherwise handled something (a type of motion), according to the estimated motion of the worker P; and (4) the step identification section 15 considers the order of occurrence of the events (1) to (3) and judges whether these events occur continuously or intermittently. By accumulating these judging factors, the step identification section 15 can identify the current step performed by the worker P with high precision.

Note that, however, the motion of the worker P does not always correspond to any of the work procedures in the four steps 21, 22, 23, and 24 described in the work procedure manual 20. Due to an oversight, a mistake, or other causes, there may possibly be a discrepancy between the work performed by the worker P and the steps.

To address this situation, the step identification section 15 in the present embodiment is configured to determine that the motion of the worker P has deviated from the work procedures, when the motion of the worker P estimated by the motion estimation section 13 corresponds to none of the work procedures in the plurality of steps 21, 22, 23, and 24. In other words, the step identification section 15 not only has a function of identifying the current step performed by the worker P but also has a function of determining that the motion of the worker P has deviated from the work procedures.

To be more specific, the step identification section 15 is configured to determine whether the motion of the worker P estimated by the motion estimation section 13 corresponds to any of the work procedures in the steps 21, 22, 23, and 24 described in the work procedure manual 20. If so, the step identification section 15 goes on to identify the current step performed by the worker P. If not, the step identification section 15 goes on to determine that the motion of the worker P has deviated from the work procedures.

When the step identification section 15 has determined that the motion of the worker P has deviated from the work procedures, the instruction section 17 is configured to give a warning to the worker P by activating a loudspeaker (an alarm section) 7. The warning given to the worker P from the loudspeaker 7 allows the worker P to recognize easily that his/her motion has deviated from the work procedures.

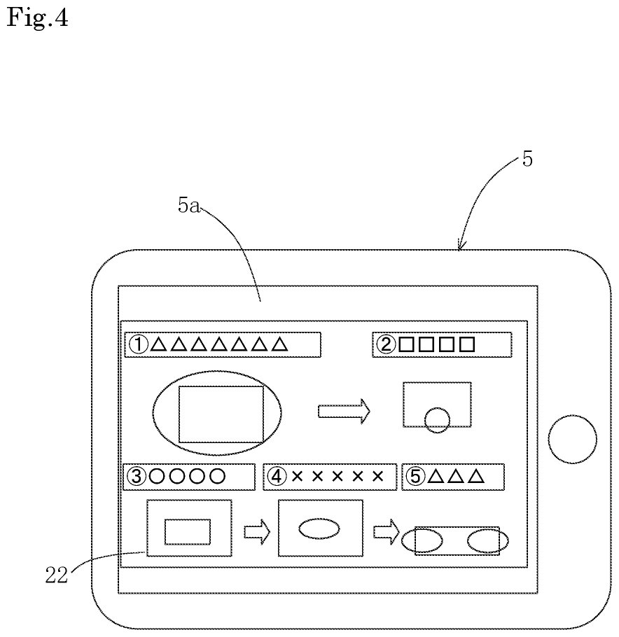

FIG. 4 is a schematic drawing that illustrates an example of a work procedure presented to the worker P. The tablet computer (a display section) 5 is positioned, for example, on the work station 30 in an easily visible manner from the worker P. As shown in FIG. 4, the work procedure manual 20 is converted to electronic data, and an image indicating the work procedure in each step is presented to the worker P via a display screen 5a.

When the step identification section 15 has identified the current step performed by the worker P, the instruction section 17 is configured to allow the tablet computer 5 to present a work procedure in a step that follows the identified current step (a next step), in advance of the next step. For example, when the step identification section 15 has identified that the current step performed by the worker P is the step 21 described in the work procedure manual 20, the instruction section 17 allows the tablet computer 5 to present the work procedure in the next step 22 on the display screen 5a, as shown in FIG. 4. In the cell manufacturing system in which the work procedure manual 20 tends to be complicated, this configuration can save the trouble of consulting the work procedure manual 20 again and again to check the work procedure in the next step, and can thereby reduce the burden on the worker P.

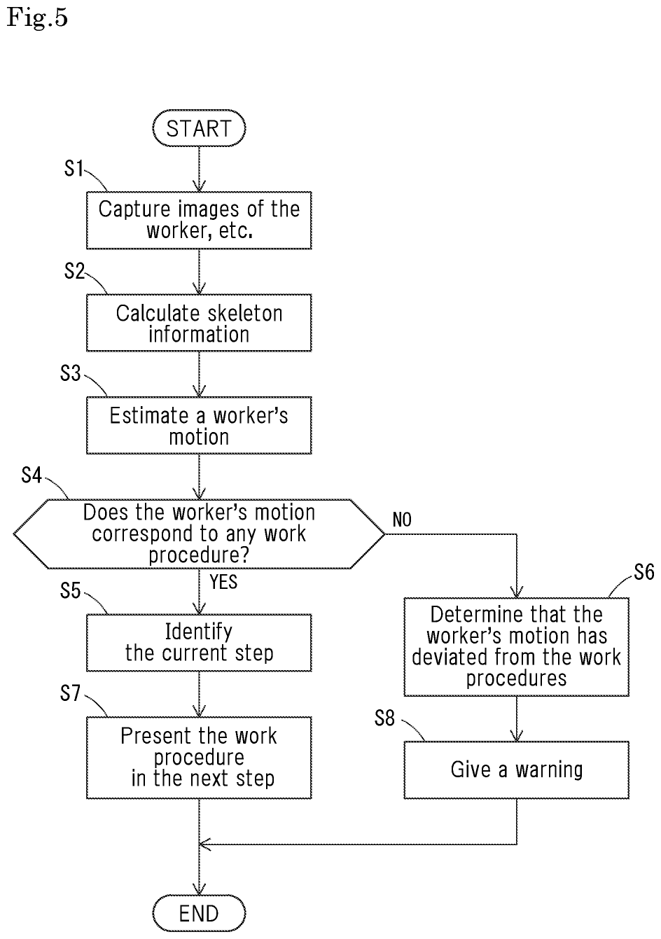

Next referring to the flowchart in FIG. 5, an example of a process according to the work instruction system 1 is described.

In step S1, the camera 3 sequentially captures images of the worker P at work, the top surface of the work station 30, and the like. The input section 11 processes image data transmitted from the camera 3. Information on the posture of the worker P is thus acquired in step S1.

In step S2, the motion estimation section 13 extracts the joints J of the worker P from the sequentially captured image data, and calculates the skeleton information on the worker P from the extracted joints J. In step S3, the motion estimation section 13 estimates a specific motion of the worker P, based on the skeleton information calculated in step S2.

In step S4, the step identification section 15 determines, by AI-based machine learning, whether the estimated motion of the worker P corresponds to any of the work procedures in the steps 21, 22, 23, and 24 described in the work procedure manual 20. If the determination in step S4 is NO, namely, if the estimated motion of the worker P corresponds to none of the work procedures in the plurality of steps 21, 22, 23, and 24, the process goes to step S6.

In step S6, the step identification section 15 determines that the motion of the worker P has deviated from the work procedures, and then the process goes to step S8. In step S8, the instruction section 17 activates the loudspeaker 7 to give a warning to the worker P, and the process ends thereafter.

In contrast, if the determination in step S4 is YES, the process goes to step S5. In step S5, the step identification section 15 identifies the current step performed by the worker P, and then the process goes to step S7. In step S7, the instruction section 17 presents, according to the current step identified in step S5, the work procedure in the next step to the worker P via the display screen 5a of the tablet computer 5, and the process ends thereafter.

The process shown in FIG. 5 is executed repeatedly while the worker P is at work. Hence, when a warning is given to the worker P in step S8 to notify the worker P that his/her motion has deviated from the work procedures, the process returns to START. Later, when the notified worker P performs the work procedure properly, the work procedure in the next step is presented to the worker P in step S7.

### OTHER EMBODIMENTS

The present invention is not limited to the above embodiment, and can be embodied and practiced in other different forms without departing from the spirit and essential characteristics of the invention.

The above-described embodiment acquires the information on the posture of the worker P by using the camera 3, but the present invention should not be limited thereto. For example, a 3D sensor (not shown) may be used alone or in combination with the camera 3 to acquire the information on the posture of the worker P.

The above-described embodiment gives a warning to the worker P by using the loudspeaker 7, but the present invention should not be limited thereto. For example, the present invention may omit the loudspeaker 7, and may give a warning to the worker P by utilizing an audio feature of the tablet computer 5 or a blinking feature of the display screen 5a of the tablet computer 5.

The above-described embodiment gives a warning to the worker P in response to the determination that the motion of the worker P has deviated from the work procedures, but the present invention should not be limited thereto. For example, while the warning is given, a proper work procedure to be currently executed may be presented on the display screen 5a of the tablet computer 5.

The above-described embodiment presents the work procedure in the next step on the tablet computer 5, but the present invention should not be limited thereto. For example, the work procedure in the next step may be presented on a screen or a monitor installed near the worker P, a smartphone carried by the worker P, or the like.

Therefore, the above-described embodiment is considered in all respects as illustrative and not restrictive. All variations and modifications falling within the equivalency range of the appended claims are intended to be embraced in the present invention. The present application claims priority to Japanese Patent Application No. 2021-059280. The contents of this application are entirely incorporated herein by reference.

### INDUSTRIAL APPLICABILITY

The present invention reliably enables a worker to recognize the work procedure in the next step, by a simple configuration without attaching any detection device to the worker and to a component, a jig, etc. Eventually, the present invention is applicable and highly beneficial to the work instruction system that automatically presents work procedures to the worker.

### REFERENCE SIGNS LIST

1 work instruction system
3 camera (information acquisition section)
5 tablet computer (display section)
7 loudspeaker (alarm section)
11 input section (information acquisition section)
13 motion estimation section
15 step identification section
17 instruction section
P worker

1. A work instruction system that automatically presents a work procedure in a next step to a worker, based on current work progress by the worker,
the work instruction system comprising:
an information acquisition section that acquires information on a posture of the worker;
a motion estimation section that calculates skeleton information on the worker and estimates a motion of the worker, based on the information acquired by the information acquisition section;
a step identification section that identifies a current step performed by the worker, based on the motion of the worker estimated by the motion estimation section and also based on work procedures that are predetermined respectively in a plurality of steps;
a display section that is capable of presenting, to the worker, an image indicating one of the work procedures in the plurality of steps; and
an instruction section that allows the display section to present, from among the work procedures in the plurality of steps, a work procedure in the next step that follows the current step identified by the step identification section.

2. The work instruction system according to claim 1,
further comprising an alarm section that is capable of giving a warning to the worker,
wherein, when the motion of the worker estimated by the motion estimation section corresponds to none of the work procedures in the plurality of steps, the step identification section is configured to determine that the motion of the worker has deviated from the work procedures, and
wherein, when the step identification section has determined that the motion of the worker has deviated from the work procedures, the instruction section is configured to activate the alarm section.
